(19) United States
(12) Patent Application Publication
(10) Pub. No.: US 2025/0207741 A1
(43) Pub. Date: Jun. 26, 2025

(54) LED LAMP BASED ON DOB DESIGN

(71) Applicant: Xiamen Topstar Lighting Co., Ltd., Xiamen (CN)

(72) Inventors: Yongjie WU, Xiamen (CN); Wenda WEN, Xiamen (CN); Ya RAO, Xiamen (CN); Yebiao HUANG, Xiamen (CN)

(73) Assignee: Xiamen Topstar Lighting Co., Ltd., Xiamen (CN)

(21) Appl. No.: 19/078,625

(22) Filed: Mar. 13, 2025

(30) Foreign Application Priority Data
Jun. 11, 2024 (CN) 202421309402.5

(51) Int. Cl. F21K 9/238; F21K 9/69; F21V 23/04

(52) U.S. Cl. CPC F21K 9/238; F21K 9/69; F21V 23/04

(57) ABSTRACT

An LED lamp includes a light source board, a switch assembly, a switch control, and a housing. The light source board is disposed in the housing; the switch assembly is disposed at an edge position of the light source board, and a toggle end of the switch assembly is movably disposed on a lower side of the light source board; the switch control is movably disposed on a side wall of the housing; and the switch control is connected to the toggle end of the switch assembly. Since the switch assembly is disposed at the edge position of the light source board, and the toggle end of the switch assembly is disposed on a lower side of the light source board, the problem that a switch assembly blocks light in the related technologies is effectively solved.

### CROSS-REFERENCE TO RELATED APPLICATIONS

This application claims priority to Chinese Patent Application No. 202421309402.5, filed on Jun. 11, 2024, the content of which is incorporated herein by reference in its entirety.

### TECHNICAL FIELD

The present application relates to the technical field of lighting equipment, in particular to a Light Emitting Diode (LED) lamp based on driver on board (DOB) design.

### BACKGROUND

In related technologies, switching of the color temperature of an LED lamp is usually achieved based on a switch, which is usually provided on a housing of the LED lamp. However, in the application scenario of DOB, since a light source board cannot adopt double-panel design, a switch may only be provided on a light emitting side of the light source board, resulting in the problem that the switch blocks light when disposed on the light source board. The statements herein provide only background information relevant to the present application and do not necessarily constitute the prior art.

### SUMMARY

An LED lamp based on DOB design includes a light source board, a switch assembly, a switch control, and a housing; the light source board is disposed in the housing; the switch assembly is disposed at an edge position of the light source board, and a toggle end of the switch assembly is movably disposed on a back side of the light source board; the switch control is movably disposed on a side wall of the housing; and a control end of the switch control penetrates through the side wall of the housing to be connected to the toggle end of the switch assembly.

### BRIEF DESCRIPTION OF THE DRAWINGS

FIG. 1 is an exploded view of an LED lamp based on DOB design according to one or more embodiments.

FIG. 2 is an overall view of an LED lamp based on DOB design according to one or more embodiments.

FIG. 3 is a schematic structural diagram of a first type of switch assembly according to one or more embodiments.

FIG. 4 is a schematic structural diagram of a second type of switch assembly according to one or more embodiments.

FIG. 5 is a schematic structural diagram of a third type of switch assembly according to one or more embodiments.

FIG. 6 is an enlarged view of a structure labeled as Part A in FIG. 1.

FIG. 7 is a schematic structural diagram of a switch control according to one or more embodiments.

FIG. 8 is a schematic diagram of connection of a switch control and a housing according to one or more embodiments.

### DETAILED DESCRIPTION OF THE EMBODIMENTS

The technical content, achieved objectives and effects of the present application are described below in detail in conjunction with implementations and accompanying drawings.

An LED lamp based on DOB design includes a light source board, a switch assembly, a switch control, and a housing; the light source board is disposed in the housing; the switch assembly is disposed at an edge position of the light source board, and a toggle end of the switch assembly is movably disposed on a lower side of the light source board; the switch control is movably disposed on a side wall of the housing; and the switch control is connected to the toggle end of the switch assembly.

As can be seen from the above description, since the switch assembly is disposed at the edge position of the light source board, the toggle end of the switch assembly is closer to the side wall of the housing, which is more conducive to controlling the switch assembly by means of the switch control, and reduces the influence on the arrangement of a light source on the light source board; at the same time, since the toggle end of the switch assembly is disposed on the lower side of the light source board, the problem that the switch assembly blocks light in the related technologies is effectively solved.

In some embodiments, the switch assembly includes a connection plate and a switch member; the light source board is provided with a mounting hole; the connection plate is connected to the light source board through the mounting hole; and the switch member is disposed on the connection plate.

As can be seen from the above description, since the light source board is provided with the mounting hole, and the switch member is connected to the light source board through cooperation of the mounting hole and the connection plate, connection between the light source board and the switch member is achieved.

In some embodiments, the connection plate is perpendicular to the light source board, and is provided on the back side of the light source board.

As can be seen from the above description, since the connection plate is disposed on the back side of the light source board, the problem that the switch assembly blocks light is solved; moreover, since the connection plate is perpendicular to the light source board, design requirements in different scenarios are met.

In some embodiments, a side of the connection plate is provided with a connection portion matching the mounting hole, and the connection portion is plugged into the mounting hole.

As can be seen from the above description, since the connection plate is provided with the connection portion, the connection plate is vertically connected to the light source board through plugged fit between the connection portion and the mounting hole; moreover, since the light source board cannot adopt the double-panel design, if the connection plate is connected in parallel to the light source board, the connection plate needs to be disposed on a light emitting side of the light source board, while by adopting the plugged manner, the switch assembly can be disposed on the back side of the light source board as a whole, which effectively solves the problem that the switch assembly blocks light.

In some embodiments, the connection plate is parallel to the light source board.

As can be seen from the above description, since the connection plate is parallel to the light source board, design requirements for switch controlling in different scenarios are met.

In some embodiments, the connection plate covers the mounting hole; a size of the mounting hole matches a size of the switch member; and the switch member is disposed in the mounting hole and connected to the connection plate.

As can be seen from the above description, since the size of the mounting hole matches the size of the switch member, the switch member can penetrate through the mounting hole as a whole to be disposed on the back side of the light source board, which reduces the height of the switch assembly on the light emitting side of the light source board, and effectively solves the problem that the switch assembly blocks light.

In some embodiments, the switch member is plugged into the connection plate, or the switch member is affixed to the connection plate.

As can be seen from the above description, since the switch member is vertically plugged into the connection plate, or the switch member is affixed to the connection plate in parallel, design requirements in different switch controlling scenarios can be met.

In some embodiments, the switch assembly includes a patch switch; the light source board is provided with an avoidance hole, and the patch switch is disposed on the avoidance hole; and
a toggle end of the patch switch penetrates through the avoidance hole to be connected to the switch control, and the toggle end of the patch switch is movable within the avoidance hole.

As can be seen from the above description, the light source board is provided with the avoidance hole, the toggle end of the patch switch penetrates through the avoidance hole after the patch switch is disposed on the avoidance hole, the toggle end of the patch switch is accordingly disposed below the light source board, and then the switch control on the housing is connected to the toggle end of the patch switch, so that connection between the switch assembly and the light source board is achieved without a connection plate.

In some embodiments, pins of the patch switch are single-stage stepped, and a connection side of each pin is connected in parallel to the light source board.

As can be seen from the above description, since the pins of the patch switch are single-stage stepped, the connection side of each pin is made parallel to the light source board, and thus the patch switch can be connected to the light source board in the form of a patch, which solves the problem that patch connection cannot be achieved when the pins of the switch are perpendicular to the light source board.

In some embodiments, the light source board is provided with a first limiting structure; and the housing is provided with a second limiting structure in clamped connection with the first limiting structure.

As can be seen from the above description, since the light source board is provided with the first limiting structure and the housing is provided with the second limiting structure, the light source board not only can be fixed, but also can be positioned, and the toggle end of the switch assembly is aligned with the switch control.

In some embodiments, a side of the switch control facing the housing is provided with a linkage portion, and a side of the switch control away from the housing is provided with a toggling portion; a sliding groove is provided in a side wall of the housing; the switch control is slidably connected to the sliding groove; the linkage portion penetrates through the sliding groove to be connected to the toggle end of the switch assembly; and the toggling portion is used for toggling control.

As can be seen from the above description, since the sliding groove is provided in the side wall of the housing, the switch control slides within the defined space of the sliding groove; and since the toggling portion and the linkage portion are disposed on the two sides of the switch control respectively, the switch control is easier to operate while controllable connection between the switch control and the switch assembly is achieved.

In some embodiments, a side of the switch control facing the housing is further provided with clamping portions; the clamping portions are provided at two ends of the linkage portion in a sliding direction; and a width of each clamping portion is greater than a width of the sliding groove.

As can be seen from the above description, since the switch control is provided with the clamping portions and the width of each clamping portion is greater than the width of the sliding groove, the switch control is prevented from disengaging from the sliding groove.

In some embodiments, an end of each clamping portion away from the toggling portion is provided with a clamping block; and the clamping blocks are slidably connected to inner walls of the sliding groove.

As can be seen from the above description, since the clamping blocks are disposed at one end of the toggling portion, the problem that the switch control disengages from the sliding groove is effectively solved by means of the clamped connection between the clamping blocks and the inner walls of the sliding groove.

In some embodiments, the LED lamp further includes a lamp cap; the lamp cap is disposed at an end of the housing away from the light source board; and the lamp cap is used for being connected to a circuit on the light source board.

As can be seen from the above description, by providing the lamp cap, the circuit on the light source board is connected to the outside of a lamp body, so that power is supplied to the light source board through the lamp cap.

In some embodiments, the LED lamp further includes a diffusion cover; and the diffusion cover is disposed on the light source board and connected to the housing.

As can be seen from the above description, since the light source board is provided with the diffusion cover, a light source can have a better light emitting effect.

The LED lamp based on DOB design provided in the present application can be applied to the scenarios of intelligent LED lamps, for example, the switching of the color temperature, brightness, etc. of the LED lamp is achieved by means of DOB. The following illustrates specific implementations.

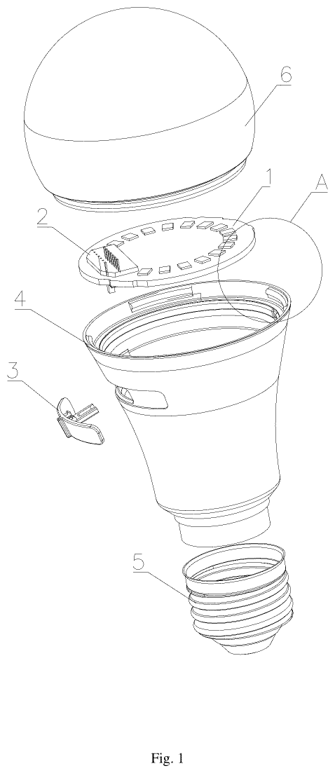

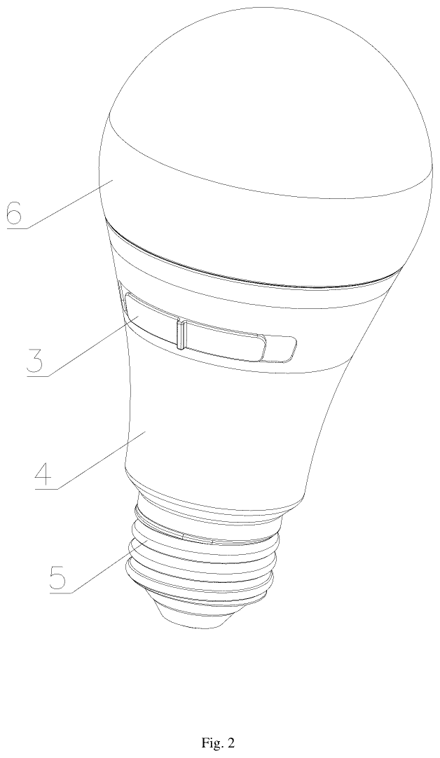

Referring to FIG. 1 and FIG. 2, an LED lamp based on DOB design includes a light source board 1, a switch assembly 2, a switch control 3, a housing 4, a lamp cap 5, and a diffusion cover 6. The light source board 1 is disposed in the housing 4. The switch assembly 2 is disposed at an edge position of the light source board 1, and a toggle end 24 of the switch assembly 2 is movably disposed on a back side of the light source board 1, the back side referring to the side of the light source board 1 on which no light source is provided. The switch control 3 is movably disposed on a side wall of the housing 4, and a control end of the switch control 3 penetrates through the side wall of the housing 4 to be connected to the toggle end 24 of the switch assembly 2, that is, the switch control 3 is toggled to achieve control over the toggle end 24 of the switch assembly 2, and after a control circuit receives a toggle state of the toggle end 24, switching of the color temperature, brightness, etc. is achieved. The lamp cap 5 is disposed at an end of the housing 4 away from the light source board 1. The lamp cap 5 is used for being connected to a circuit on the light source board 1, that is, the lamp cap 5 is used for being connected to an external power supply and inputting the external power supply into a lamp body to supply power for an internal circuit. The diffusion cover 6 is disposed on the light source board 1, and is connected to the housing 4. A clamping groove is provided in a bottom of the diffusion cover 6, and a clamping strip matching the clamping groove is disposed on a top of the housing 4. The clamped connection between the diffusion cover 6 and the housing 4 is achieved through the clamping groove and the clamping strip.

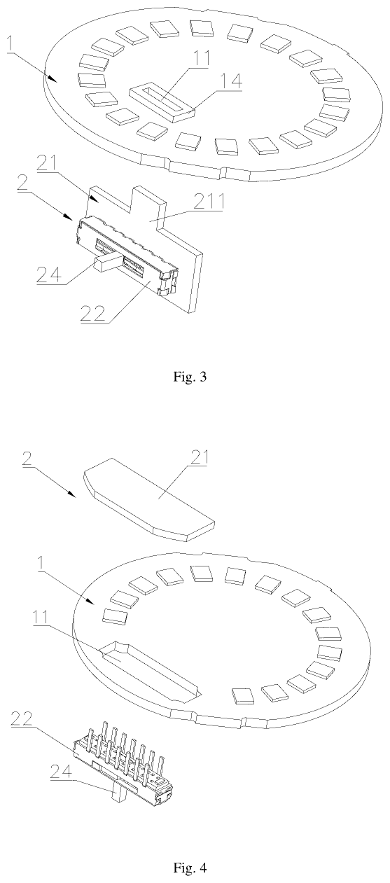

Referring to FIG. 3 and FIG. 4, in some alternative implementations, the switch assembly 2 includes a connection plate 21 and a switch member 22; the light source board 1 is provided with a mounting hole 11; the connection plate 21 is connected to the light source board 1 through the mounting hole 11; and the switch member 22 is disposed on the connection plate 21. The switch member 22 is disposed on the connection plate 21 in a plugged manner, or the switch member 22 is disposed on the connection plate 21 in an affixed manner.

Referring to FIG. 3, in some implementations, the connection plate 21 is perpendicular to the light source board 1 and is disposed on the back side of the light source board 1. Specifically, a side of the connection plate 21 is provided with a connection portion 211 that matches the mounting hole 11, and the connection portion 211 is plugged into the mounting hole 11. At the same time, the connection portion 211 and the mounting hole 11 are provided with soldering joints for welding the connection portion 211 to the mounting hole 11. The control circuit is disposed on the connection plate 21 or on the light source board 1. By welding the connection portion 211 to the mounting hole 11, the connection of the switch member 22, the control circuit, and the light source is achieved. To further improve the strength of the connection between the connection portion 211 and the mounting hole 11, the light source board 1 is provided with an auxiliary plate 14, so that the connection portion 211 penetrates through the mounting hole 11 and the auxiliary plate 14 in sequence and is welded to the light source board 1.

Referring to FIG. 4, in some implementations, the connection plate 21 is parallel to the light source board 1. Specifically, the connection plate 21 covers the mounting hole 11; the size of the mounting hole 11 matches the size of the switch member 22; and the switch member 22 is disposed in the mounting hole 11 and is connected to the connection plate 21. In some other implementations, the connection plate 21 is provided with a vertical connection portion 211, and the connection portion 211 is connected vertically to the light source board 1, so that the connection plate 21 is parallel to the light source board 1. Thus, the problem that when the connection plate 21 is disposed parallel to the light source board 1, the connection plate needs to be disposed on a light emitting side of the light source board is solved.

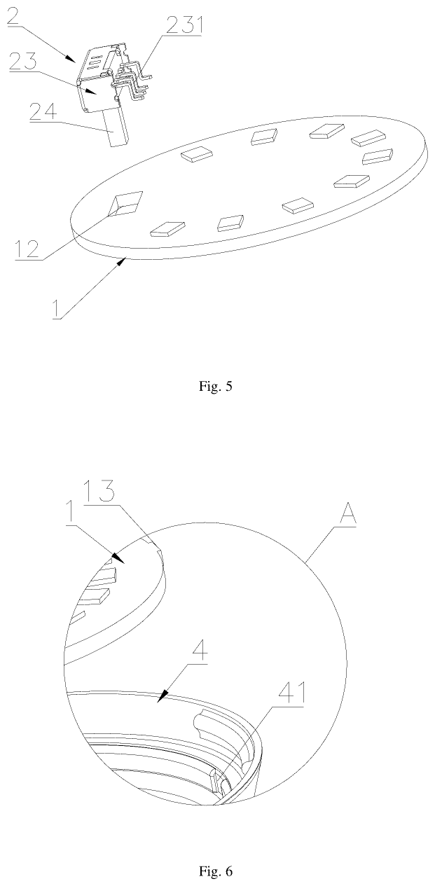

Referring to FIG. 5, in some implementations, the switch assembly 2 includes a patch switch 23; the light source board 1 is provided with an avoidance hole 12, and the patch switch 23 is disposed on the avoidance hole 12; a toggle end 24 of the patch switch 23 penetrates through the avoidance hole 12 to be connected to the switch control 3; and the toggle end 24 of the patch switch 23 is movable within the avoidance hole 12. Pins 231 of the patch switch 23 are single-stage stepped, and a connection side of each pin 231 is connected in parallel to the light source board 1. As shown in FIG. 5, the pins 231 of the patch switch 23 are partially disposed on the light emitting side of the light source board 1, and the toggle end 24 of the patch switch 23 penetrates through the avoidance hole 12 to be disposed on the back side of the light source board 1, so that the toggle end 24 of the patch switch 23 may be connected to the switch control 3.

The switch member 22 or the patch switch 23 in the implementation described above has a plurality of gears, for example, each has 6 gears. If the switch assembly 2 is used for switching of the color temperature, switching of the color temperature of gear 1, gear 2, gear 3, gear 4, gear 5 and gear 6 can be achieved; and if the switch assembly 2 is applied to switching of brightness, switching of brightness of gear 1, gear 2, gear 3, gear 4, gear 5 and gear 6 can be achieved.

Referring to FIG. 6, the light source board 1 is provided with a first limiting structure 13, and the housing 4 is provided with a second limiting structure 41 in clamped connection with the first limiting structure 13. The first limiting structure 13 and the second limiting structure 41 play roles in fixing and positioning the light source board 1, so that the toggle end 24 of the switch assembly 2 is aligned with a linkage portion 31 of the switch control 3. For example, in some implementations, the first limiting structure 13 is a limiting block and the second limiting structure 41 is a limiting groove; or, the first limiting structure 13 is a limiting groove and the second limiting structure 41 is a limiting block. Thus, the first limiting structure 13 and the second limiting structure 41 are in concave-convex clamped fit.

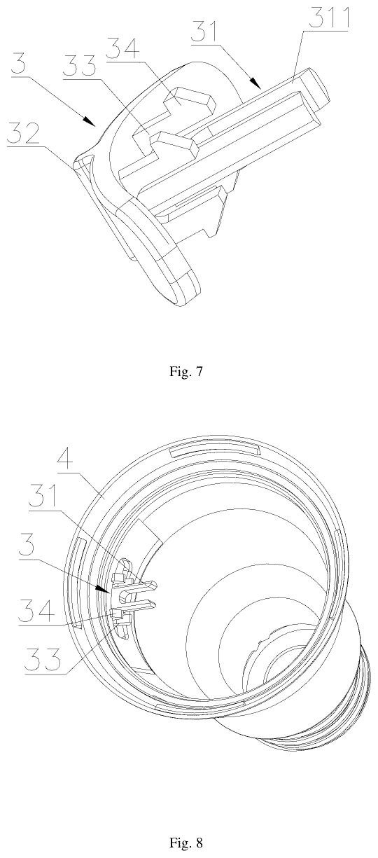

Referring to FIG. 7 and FIG. 8, a side of the switch control 3 facing the housing 4 is provided with a linkage portion 31 and clamping portions 33, and a side of the switch control away from the housing 4 is provided with a toggling portion 32. The linkage portion 31 is a control end of the switch assembly 2. A sliding groove 42 is provided in a side wall of the housing 4. The switch control 3 is slidably connected to the sliding groove 42. The linkage portion 31 penetrates through the sliding groove 42 to be connected to the toggle end 24 of the switch assembly 2. The toggling portion 32 is used for toggling control. The clamping portions 33 are provided at two ends of the linkage portion 31 in a sliding direction, and a width of each clamping portion 33 is greater than a width of the sliding groove 42. The linkage portion 31 includes two toggling levers 311, and the toggle end 24 of the switch assembly 2 is disposed between the two toggling levers 311, so that the switch control 3, when sliding, may drive the toggle end of the switch assembly 2 to slide together, thereby achieving gear switching. In other alternative implementations, the linkage section 31 is connected in the form of a half-wrap to the toggle end 24 of the switch assembly 2. An end of each clamping portion 33 away from the toggling portion 32 is provided with a clamping block 34, and the clamping blocks 34 are slidably connected to inner walls of the sliding groove 42. As shown in FIG. 8, the clamping block 34 located on the upper portion is clamped to the upper inner wall of the sliding groove 42, and the clamping block 34 located on the lower portion is clamped to the lower inner wall of the sliding groove 42, so that the switch control 3 is prevented from disengaging from the sliding groove 42.

Taking the switch assembly 2 being used for switching of the color temperature as an example, the working principle of the LED lamp based on DOB design described above is as follows.

When a color temperature gear needs to be switched, the switch control 3 is made to move to the left or to the right by toggling the toggling portion 32 of the switch control 3, e.g., to the left for lowering the gear and to the right for increasing the gear. When the switch control 3 is moved, the switch control 3 is made to slide along the sliding groove 42 by means of the clamping blocks 34 on the clamping portions 33. Meanwhile, as the linkage portion 31 is clamped to the toggle end 24 of the switch member 22 or the patch switch 23, the toggle end 24 of the switch member 22 or the patch switch 23 is toggled, that is, the switch member 22 or the patch switch is triggered to switch the gears, and then the control circuit receives the toggle state of the toggle end 24, so that adjustment of the color temperature of the LED lamp is achieved.

In summary, according to the LED lamp based on DOB design provided by the present application, since the switch assembly is disposed at the edge position of the light source board, the toggle end of the switch assembly is closer to the side wall of the housing, which is more conducive to controlling the switch assembly by means of the switch control, and reduces the influence on the arrangement of a light source on the light source board; at the same time, since the toggle end of the switch assembly is disposed on the lower side of the light source board, the problem that the switch assembly blocks light in the related technologies is effectively solved.

The above are merely embodiments of the present application, and are not intended to limit the scope of the patent of the present application. Any equivalent transformation made by utilizing the contents of the specification and accompanying drawings of the present application, or directly or indirectly applying them in the related technical fields, similarly fall within the scope of protection of the patent of the present application.

What is claimed is:

1. A Light Emitting Diode (LED) lamp based on driver on board (DOB) design, comprising a light source board, a switch assembly, a switch control, and a housing, wherein
the light source board is disposed in the housing;
the switch assembly is disposed at an edge position of the light source board, and a toggle end of the switch assembly is movably disposed on a back side of the light source board; and
the switch control is movably disposed on a side wall of the housing, and a control end of the switch control penetrates through the side wall of the housing to be connected to the toggle end of the switch assembly.

2. The LED lamp based on DOB design according to claim 1, wherein the switch assembly comprises a connection plate and a switch member;
the light source board is provided with a mounting hole;
the connection plate is connected to the light source board through the mounting hole; and
the switch member is disposed on the connection plate.

3. The LED lamp based on DOB design according to claim 2, wherein the connection plate is perpendicular to the light source board, and is provided on the back side of the light source board.

4. The LED lamp based on DOB design according to claim 3, wherein one side of the connection plate is provided with a connection portion matching the mounting hole, and the connection portion is plugged into the mounting hole.

5. The LED lamp based on DOB design according to claim 2, wherein the connection plate is parallel to the light source board.

6. The LED lamp based on DOB design according to claim 5, wherein the connection plate covers the mounting hole;
a size of the mounting hole matches a size of the switch member; and
the switch member is disposed in the mounting hole and connected to the connection plate.

7. The LED lamp based on DOB design according to claim 2, wherein the switch member is plugged into the connection plate, or the switch member is affixed to the connection plate.

8. The LED lamp based on DOB design according to claim 1, wherein the switch assembly comprises a patch switch;
the light source board is provided with an avoidance hole, and the patch switch is disposed on the avoidance hole; and
a toggle end of the patch switch penetrates through the avoidance hole to be connected to the switch control, and the toggle end of the patch switch is movable within the avoidance hole.

9. The LED lamp based on DOB design according to claim 8, wherein pins of the patch switch are single-stage stepped, and a connection side of each pin is connected in parallel to the light source board.

10. The LED lamp based on DOB design according to claim 1, wherein the light source board is provided with a first limiting structure; and
the housing is provided with a second limiting structure in clamped connection with the first limiting structure.

11. The LED lamp based on DOB design according to claim 1, wherein a side of the switch control facing the housing is provided with a linkage portion, and a side of the switch control away from the housing is provided with a toggling portion;
a sliding groove is provided in a side wall of the housing;
the switch control is slidably connected to the sliding groove;
the linkage portion penetrates through the sliding groove to be connected to the toggle end of the switch assembly; and
the toggling portion is used for toggling control.

12. The LED lamp based on DOB design according to claim 11, wherein a side of the switch control facing the housing is further provided with clamping portions;
the clamping portions are provided at two ends of the linkage portion in a sliding direction; and
a width of each clamping portion is greater than a width of the sliding groove.

13. The LED lamp based on DOB design according to claim 12, wherein an end of each clamping portion away from the toggling portion is provided with a clamping block; and
the clamping blocks are slidably connected to inner walls of the sliding groove.

14. The LED lamp based on DOB design according to claim 1, further comprising a lamp cap, wherein
the lamp cap is disposed at an end of the housing away from the light source board; and
the lamp cap is used for being connected to a circuit on the light source board.

15. The LED lamp based on DOB design according to claim 1, further comprising a diffusion cover, wherein
the diffusion cover is disposed on the light source board and connected to the housing.
